(19) United States
(12) Patent Application Publication
(10) Pub. No.: US 2022/0036131 A1
(43) Pub. Date: Feb. 3, 2022

(54) METHOD FOR LABELING IMAGE OBJECTS

(71) Applicant: NADI SYSTEM CORP., Taipei City (TW)

(72) Inventor: Syuan-Pei CHANG, Taipei City (TW)

(73) Assignee: NADI SYSTEM CORP., Taipei City (TW)

(21) Appl. No.: 17/389,469

(22) Filed: Jul. 30, 2021

(30) Foreign Application Priority Data
Jul. 30, 2020 (TW) 109125790

(51) Int. Cl. G06K 9/62; G06T 7/20; G06N 3/08

(52) U.S. Cl. CPC G06K 9/6256; G06N 3/08; G06T 7/20; G06K 9/6227

(57) ABSTRACT

The method for labeling image objects is applied to a monitoring system that comprises a plurality of cameras, a first image analysis module and a plurality of second image analysis modules, wherein the plurality of cameras capture an image, having a background and at least one object, of a real environment, and the method comprises the steps of: (a) using the first image analysis module to frame and track the at least one object; (b) separating the framed object from the background; (c) classifying the object to one of the plurality of the second image analysis modules according to one initial feature of the object; (d) the plurality of second image analysis modules analyzing the initial feature in order to obtain an advance feature; and (e) labeling the object according to the advance feature.

### BACKGROUND OF THE INVENTION

### 1. Field of the Invention

The present invention generally relates to a method for labeling image objects, more particularly to a method for separating an object from a background.

### 2. Description of the Prior Art

Presently, since labor costs continuously increasing in labor costs, more people tend to use image monitoring systems for security, in order to obtain the most comprehensive protections but with very limited human resources. There are conditions with public environmental safety, for examples as department stores, supermarkets, airports, the image monitoring systems have been applied for a long time. In addition, some image monitoring systems will introduce image recognition technology to identify various objects in the shooting area and give corresponding labels to strengthen the maintenance of public environmental safety. There are still some inconveniences existed, that is, a public environment contains many objects with different categories, so as to often happen the condition of the image monitoring systems giving wrong labels.

Therefore, how to figure out this problem is worth considering for those people who are skilled in the art.

### SUMMARY OF THE INVENTION

The main objective of the present invention provides a method for labeling image objects, and it is able to have more accurate and detail label to the object, and decreases the possibility of wrong identification.

The method for labeling image objects is applied to a monitoring system that comprises a plurality of cameras, a first image analysis module and a plurality of second image analysis modules, wherein the plurality of cameras capture an image, having a background and at least one object, of a real environment, and the method comprises the steps of: (a) using the first image analysis module to frame and track the at least one object; (b) separating the framed object from the background; (c) classifying the object to one of the plurality of the second image analysis modules according to one initial feature of the object; (d) the plurality of second image analysis modules analyzing the initial feature in order to obtain an advance feature; and (e) labeling the object according to the advance feature.

Preferably, the initial feature is a specie of the object, a location of the object, dimensions of the object, a moving speed of the object, distances between the object and each of cameras, or moving actions of the object. In some embodiments, the specie of the object is a car, boat, plane, or animal. In some embodiments, the location of the object is the real-time location of the object, such as absolute coordinates in earth or relative coordinates in indoor space.

Preferably, the advance feature is a gender of a specie when the initial feature is the specie of the object.

Preferably, one of the first image analysis module and the second analysis module has a neural network model.

Preferably, the neural network model is to execute a deep learning algorithm.

Preferably, the neural network model is a convolutional neural network model.

Preferably, the convolutional neural network model is VGG model, ResNet model or DenseNet model.

Preferably, the neural network model is YOLO model, CTPN model, EAST model, or RCNN model.

Preferably, the advance feature is the color or the volume of the object.

Preferably, the advance feature is distances between different objects.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a flow chart of a method for labeling image objects of the present invention;

FIG. 2 illustrates a schematic view of a monitoring system 20 of the present invention.

FIG. 3 illustrates a schematic three-dimensional view of a plurality of cameras 23 shooting a real environment 80 of the present invention;

FIG. 4A illustrates a schematic view of framing and tracking one of the objects 81T of the present invention; and

FIG. 4B illustrates a schematic view of one of the objects 81T being separated from the background 81B of the present invention.

### DETAILED DESCRIPTION OF THE INVENTION

Following preferred embodiments and figures will be described in detail so as to achieve aforesaid objects.

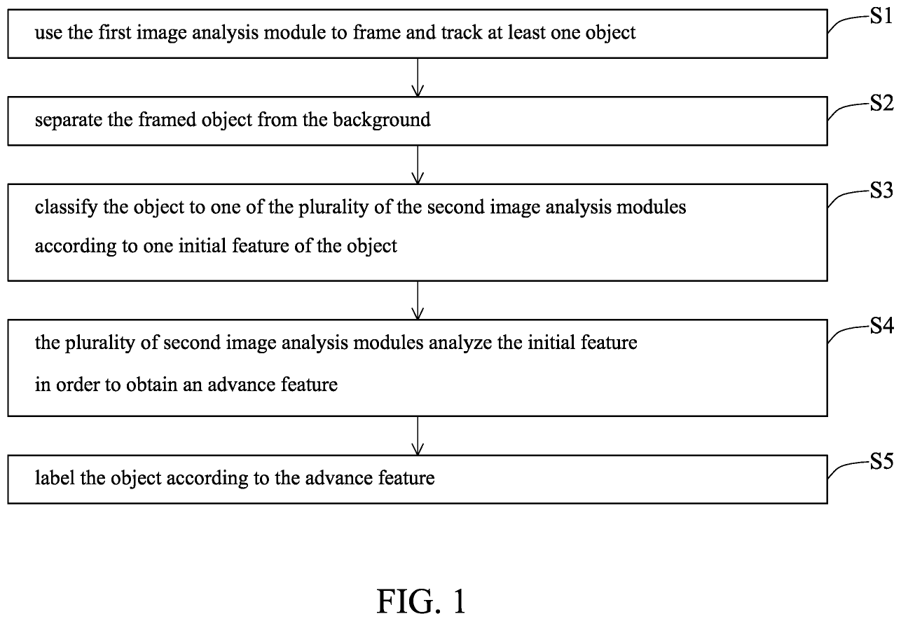

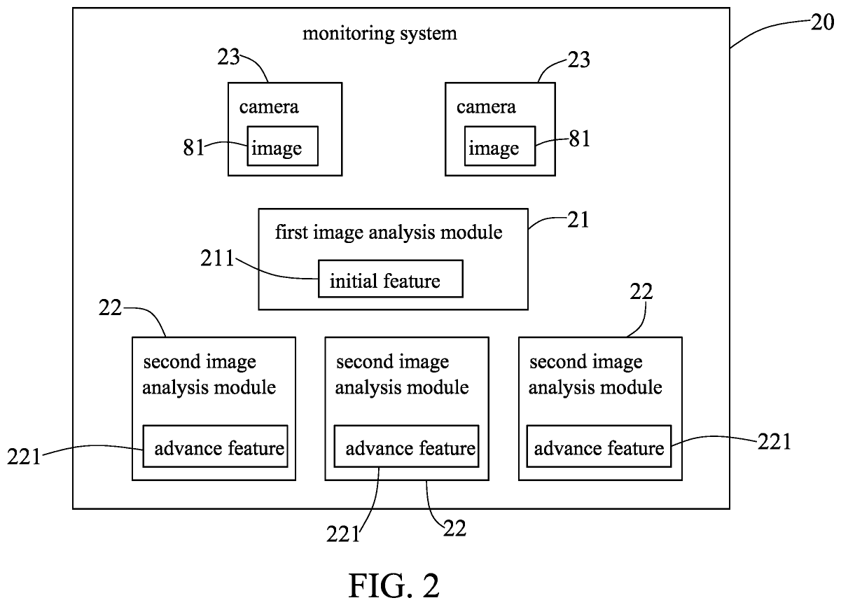

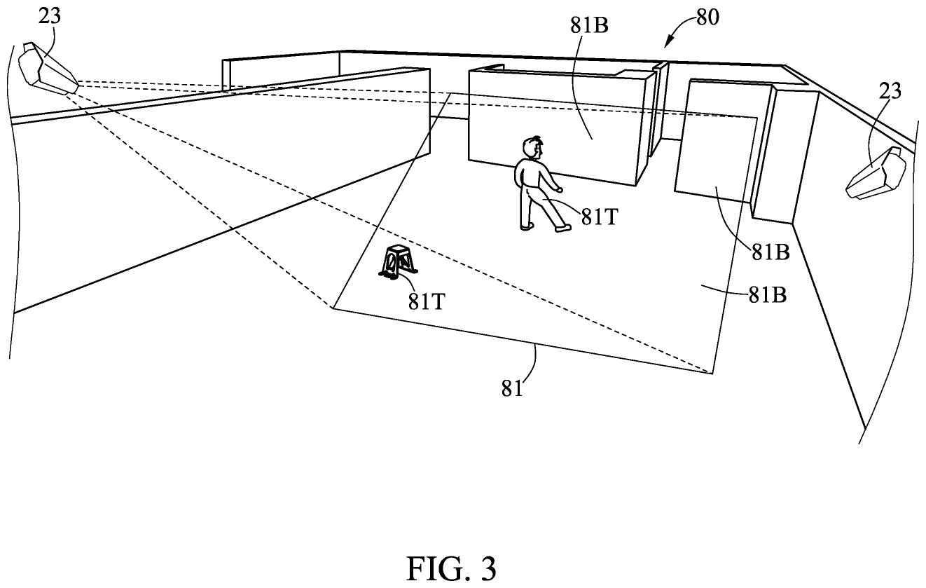

Please refer to FIG. 1, FIG. 2 and FIG. 3, which illustrate a flow chart of a method for labeling image objects of the present invention, a schematic view of a monitoring system 20 of the present invention, and a schematic three-dimensional view of a plurality of cameras 23 shooting a real environment 80 of the present invention. A preferred embodiment of the method for labeling image objects of the present invention is applied to the monitoring system 20, which includes the plurality of cameras 23 (shown two cameras 23 in FIG. 3 as an example), a first image analysis module 21 and a plurality of second image analysis module 22 (shown three second image analysis modules 22 in FIG. 2 as an example).

With reference to FIG. 3, the cameras 23 are to shoot the real environment 80 to obtain an image 81 that includes a background 81B and at least one object 81T (the two objects 81T shown in FIG. 3 being different properties). The background 81B takes “partition wall” and “ground” of a building as examples. The two objects 81T with different properties adopt “chair” and “human being” as examples. For the image 8, the two objects 81T are merged into the background 81B.

Please refer to FIG. 1, the method for labeling image objects includes the steps as following.

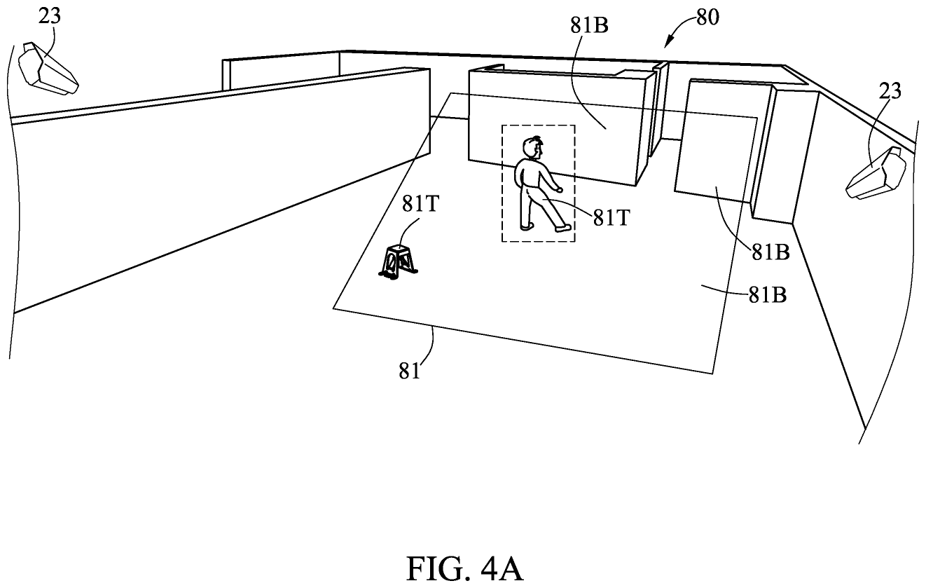

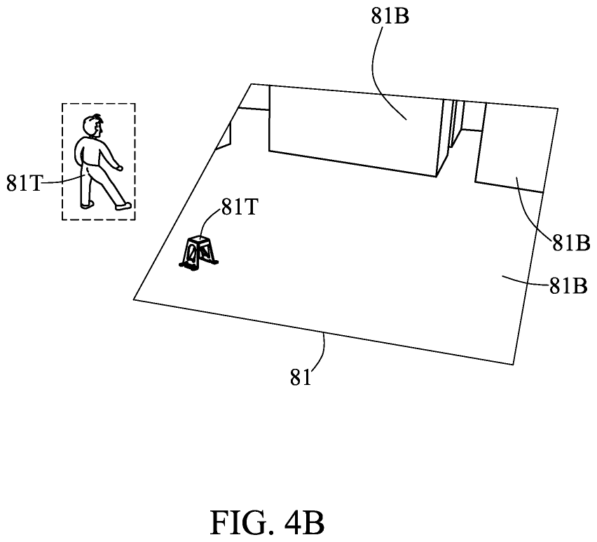

Step (S1): referring to FIG. 4A, which illustrates a schematic view of framing and tracking one of the objects 81T of the present invention. The first image analysis module 21 is used to frame and track the at least one object 81T in the image 8, wherein the framed object 81T is a “human being” image.
Step (S2): referring to FIG. 4B, which illustrates a schematic view of one of the objects 81T being separated from the background 81B of the present invention. Further, the images, “partition wall” and “ground”, are not on the location behind the framed image “human being”, so that the image of the object 81T may not be interfered by the image of the background 81B, and it is beneficial to promote an accuracy of the identified object 81T.
Step (S3): the first image analysis module 21 classifies the object 81T the object to one of the plurality of the second image analysis modules 22 according to an initial feature 211 of the object. More, the first image analysis module 21 first identifies the initial feature 211 of the object 81T, wherein the initial feature 211 can be a specie of the object 81T, location of the object 81T, dimensions of the object 81T, a moving speed of the object 81T, distances between the object 81T and each of cameras 23, and moving actions of the object 81T. For the embodiment, the initial feature 211 takes the specie of the object 81T as an example, and the specie of the object 81T is “human being”. Therefore, the initial feature 211 is “human being”. When the initial feature 211 is identified as “human being”, the object 81T with the initial feature mapping to “human being” is sent to the second image analysis module 22. In another word, the second image analysis modules 22 with the initial feature mapping to “human being” only accept the object 81T related to “human being”; others may accept the object 81T without relationship to “human being”. Specifically, one of the second image analysis module 22 accepts the object 81T with the initial feature of “pet”, another accepts the object 81T with the initial feature of “furniture”, and the third second image analysis module 21 accepts the object 81T with the initial feature of “vehicle”. As it can be seen, each of the second image analysis modules 21 only collects the object 81T with the same specie, and it benefits to precisely analyze those consequent objects 81T in order to avoid wrong identification.
Step (S4) the plurality of second image analysis modules 22 analyze the initial feature 211 in order to obtain an advance feature 211 of the object 81T. The advance feature 211 is a gender of the specie of the object 81T when the initial feature is the specie of the object 81T. For instance, the second image analysis modules 22 may proceed more analysis processes based on the initial feature of “human being”, so as to judge what the gender of “human being” is. Since the object 81T in FIG. 4A is a man, the gender of “human being” is judged as “male”. That is, the advance feature 221 of the object 81T is “male”. The second image analysis modules 21 recognize male or female based on face recognition technology.
Step (S5): the second image analysis modules 22 labels the object 81T according to the advance feature 221. Specifically, the object 81T mapping to the advance feature 221 will be labeled as “male” by the second image analysis modules 22 if the advance feature 221 of the object 81T is judged as “male”. After going through Step (S1) to Step (S5), the method for labeling the image objects of the present invention is able to decrease the possibility of wrong identification to the object 81T, and even further detail labels to the object 81T.

In some embodiment, the advance feature of the object is a color or a volume of the object. The second image analysis modules 21 evaluates the volume of the object by counting the number of pixels in the image.

In some embodiment, the advance feature is distances between different the objects. For example, the second image analysis modules 22 can determine whether the people in the image are in groups or not.

As aforesaid, the first image analysis module 21 or the second image analysis module 22 has a neural network model, in order to execute a deep learning algorithm. Further, the neural network model is a convolutional neural network model, YOLO model, CTPN model, EAST model, or RCNN model, and the convolutional neural network model is VGG model, ResNet model, or DenseNet model. We could mention that those models are good to that of the first image analysis module 21 and the second image analysis module 22 analyzing the objects 81T.

As a conclusion, the method for labeling image objects of the present invention provides more accurate and detail label to the object, and decreases the possibility of wrong identification.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A method for labeling image objects, applied to a monitoring system that comprises a plurality of cameras, a first image analysis module and a plurality of second image analysis modules, wherein the plurality of cameras capture an image, having a background and at least one object, of a real environment, comprising the steps of:
(a) using the first image analysis module to frame and track the at least one object;
(b) separating the framed object from the background;
(c) classifying the object to one of the plurality of the second image analysis modules according to one initial feature of the object;
(d) the plurality of second image analysis modules analyzing the initial feature in order to obtain an advance feature; and
(e) labeling the object according to the advance feature.

2. The method for labeling the image objects according to claim 1, wherein the initial feature is selected from the group consisting of: a specie of the object, a location of the object, dimensions of the object, a moving speed of the object, distances between the object and each of cameras, and moving actions of the object.

3. The method for labeling the image objects according to claim 2, wherein the advance feature is a gender of a specie when the initial feature is the specie of the object.

4. The method for labeling the image objects according to claim 1, wherein one of the first image analysis module and the second analysis module has a neural network model.

5. The method for labeling the image objects according to claim 4, wherein the neural network model is to execute a deep learning algorithm.

6. The method for tracking the image objects according to claim 4, wherein the neural network model is a convolutional neural network model.

7. The method for tracking the image objects according to claim 5, wherein the convolutional neural network model is selected from the group consisting of: VGG model, ResNet model, and DenseNet model.

8. The method for tracking the image objects according to claim 4, wherein the neural network model is selected from the group consisting of: YOLO model, CTPN model, EAST model, and RCNN model.

9. The method for labeling the image objects according to claim 1, wherein the advance feature is a color or a volume of the object.

10. The method for labeling the image objects according to claim 1, wherein the advance feature is distances between different objects.
